(19) United States
(12) Patent Application Publication
(10) Pub. No.: US 2016/0297484 A1
(43) Pub. Date: Oct. 13, 2016

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US); Edward D. Groninger, Macomb, MI (US); Michael Coules, New Baltimore, MI (US)

(21) Appl. No.: 14/681,154

(22) Filed: Apr. 8, 2015

(51) Int. Cl. B62D 27/02; B62D 27/04

(52) U.S. Cl. CPC B62D 27/02; B62D 27/04

(57) ABSTRACT

An elastically averaged alignment system includes a first component comprising a plurality of alignment pins forming a first group of alignment pins, and a second component comprising an inner wall defining an alignment aperture, the alignment aperture configured to receive the first group of alignment pins to couple the first component and the second component. The alignment pins comprise an elastically deformable material such that when the first group of alignment pins is inserted into the alignment aperture, at least a portion of the alignment pins of the plurality of alignment pins elastically deform to an elastically averaged final configuration to facilitate coupling and aligning the first component and the second component in a desired orientation.

### FIELD OF THE INVENTION

The subject invention relates to matable components and, more specifically, to elastically averaged matable components for precise alignment therebetween.

### BACKGROUND

Components, in particular vehicular components used in automotive vehicles, which are to be mated together in a manufacturing process may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variations in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling, and further result in the perception of poor quality.

### SUMMARY OF THE INVENTION

In one aspect, an elastically averaged alignment system is provided. The alignment system includes a first component comprising a plurality of alignment pins forming a first group of alignment pins, and a second component comprising an inner wall defining an alignment aperture, the alignment aperture configured to receive the first group of alignment pins to couple the first component and the second component. The alignment pins comprise an elastically deformable material such that when the first group of alignment pins is inserted into the alignment aperture, at least a portion of the alignment pins of the plurality of alignment pins elastically deform to an elastically averaged final configuration to facilitate coupling and aligning the first component and the second component in a desired orientation.

In another aspect, a vehicle is provided. The vehicle includes a body and an elastically averaged alignment system integrally arranged with the body. The elastically averaged alignment system includes a first component comprising a plurality of alignment pins forming a first group of alignment pins, and a second component comprising an inner wall defining an alignment aperture, the alignment aperture configured to receive the first group of alignment pins to couple the first component and the second component. The alignment pins comprise an elastically deformable material such that when the first group of alignment pins is inserted into the alignment aperture, at least a portion of the alignment pins of the plurality of alignment pins elastically deform to an elastically averaged final configuration to facilitate coupling and aligning the first component and the second component in a desired orientation.

In yet another aspect, a method of manufacturing an elastically averaged alignment system is provided. The method includes forming a first component comprising a plurality of alignment pins that form a first group of alignment pins, and forming a second component comprising an inner wall defining an alignment aperture, the alignment aperture configured to receive the first group of alignment pins to couple the first component and the second component. The alignment pins comprise an elastically deformable material such that when the first group of alignment pins is inserted into the alignment aperture, at least a portion of the alignment pins of the plurality of alignment pins elastically deform to an elastically averaged final configuration to facilitate coupling and aligning the first component and the second component in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary elastically averaged alignment system before assembly;

FIG. 2 is a perspective view of the elastically averaged alignment system shown in FIG. 1 after assembly;

FIG. 3 is a cross-sectional view of the system shown in FIG. 2 and taken along line 3-3;

FIG. 4 is a perspective view of another exemplary elastically averaged alignment system;

FIG. 5 is a perspective view of an exemplary alignment pin that may be used with the system shown in FIGS. 1-4; and

FIG. 6 is a side view of an exemplary vehicle that may utilize the elastically averaged alignment systems shown in FIGS. 1-4.

### DETAILED DESCRIPTION

The following description is merely exemplary in nature and is not intended to limit the present disclosure, its application or uses. For example, the embodiments shown are applicable to vehicle body panels, but the alignment system disclosed herein may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned U.S. Pat. No. 8,695,201, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

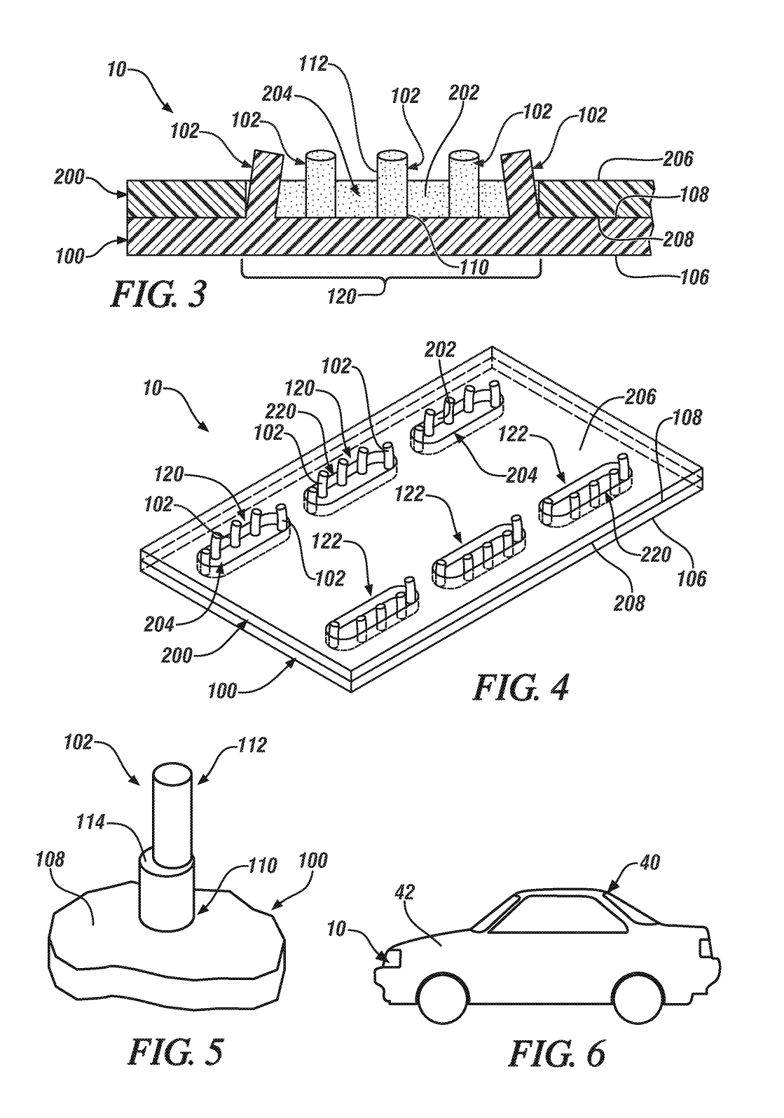

FIGS. 1-3 illustrate an exemplary elastically averaged alignment system 10 that generally includes a first component 100 to be mated to a second component 200. First component 100 includes a plurality of elastically deformable alignment posts or pins 102, and second component 200 includes an inner wall 202 defining an alignment aperture 204. Alignment pins 102 and alignment aperture 204 are fixedly disposed on or formed integrally with their respective component 100, 200 for alignment and orientation when components 100 and 200 are mated. Components 100 and 200 may have any number and combination of corresponding alignment pins 102 and alignment apertures 204. Elastically deformable alignment pins 102 are configured and disposed to interferingly, deformably, and matingly engage alignment aperture inner wall 202 as discussed herein in more detail, to precisely align first component 100 with second component 200 in two or four directions, such as the +/−x-direction and the +/−y-direction of an orthogonal coordinate system, for example, which is herein referred to as two-way and four-way alignment. Moreover, elastically deformable alignment pins 102 matingly engage alignment apertures 204 to facilitate a stiff and rigid connection between first component 100 and second component 200, thereby reducing or preventing relative movement therebetween.

In an exemplary embodiment, first component 100 generally includes an outer face 106 and an inner face 108 from which alignment pins 102 extend. Alignment pins 102 are generally solid cylindrical members having a proximal end 110 coupled to inner face 108, and a distal end 112. However, alignment pins 102 may have any cross-sectional shape that enables system 10 to function as described herein. First component 100 may optionally include: one or more stand-offs (not shown) and/or one or more alignment pins 102 having a ledge or shoulder 114 (FIG. 5) for engaging and supporting second component 200 in spaced relation to first component 100. In the exemplary embodiment, first component 100 is fabricated from a rigid material such as plastic. However, first component 100 may be fabricated from any suitable material that enables system 10 to function as described herein.

Second component 200 generally includes an outer face 206 and an inner face 208. Second component 200 may include a chamfer (not shown) formed in inner face 208 about alignment aperture 204 to facilitate insertion of alignment pins 102 into alignment aperture 204. Further, second component 200 may optionally include one or more stand-offs (not shown) for engaging and supporting first component 100 in spaced relation to second component 200. In an exemplary embodiment, alignment aperture 204 is illustrated as an elongated slot. However, alignment aperture 204 may have any shape that enables system 10 to function as described herein. For example, alignment aperture 204 may be generally circular. In the exemplary embodiment, second component 200 is fabricated from a rigid material such as sheet metal. However, second component 200 may be fabricated from any suitable material that enables system 10 to function as described herein.

While not being limited to any particular structure, first component 100 may be a decorative trim component of a vehicle with the customer-visible side being outer face 106, and second component 200 may be a supporting substructure that is part of, or is attached to, the vehicle and on which first component 100 is fixedly mounted in precise alignment. Alternatively, first component 100 may be an intermediate component located between second component support substructure 200 and a decorative trim component such as a vehicle grille (not shown).

To provide an arrangement where elastically deformable alignment pins 102 are configured and disposed to interferingly, deformably and matingly engage alignment aperture inner wall 202, the outer boundary or perimeter of alignment aperture 204 (i.e., inner wall 202) is smaller than an outer boundary or shape formed by a group 120 of alignment pins 102, which necessarily creates a purposeful interference fit between the elastically deformable alignment pin group 120 and alignment aperture inner wall 202. As such, when inserted into alignment aperture 204, portions of the elastically deformable alignment pins 102 of each group 120 elastically deform to an elastically averaged final configuration that aligns group 120 with the alignment aperture 204 in four planar orthogonal directions (the +/−x-direction and the +/−y-direction). In other arrangements, alignment pins 102 may only be aligned in two planar orthogonal directions (the +/−x-direction or the +/−y-direction). Accordingly, each associated pin group 120 and alignment aperture 204 elastically deform to align at least a portion of first component 100 and second component 200.

Further, a plurality of associated pin groups 120 and alignment apertures 204 may be utilized, for example, as illustrated in FIGS. 1-3. As such, when inserted into one alignment aperture 204, each pin group 120 elastically deforms to an elastically averaged final configuration that aligns first component 100 and second component in a desired orientation. Thus, a first elastic averaging alignment occurs as the pins 102 of one group 120 are inserted into the alignment aperture 204, and a second elastic averaging occurs across a plurality of pin group/alignment aperture pairings to precisely orient first and second components 100, 200 in two or four planar orthogonal directions.

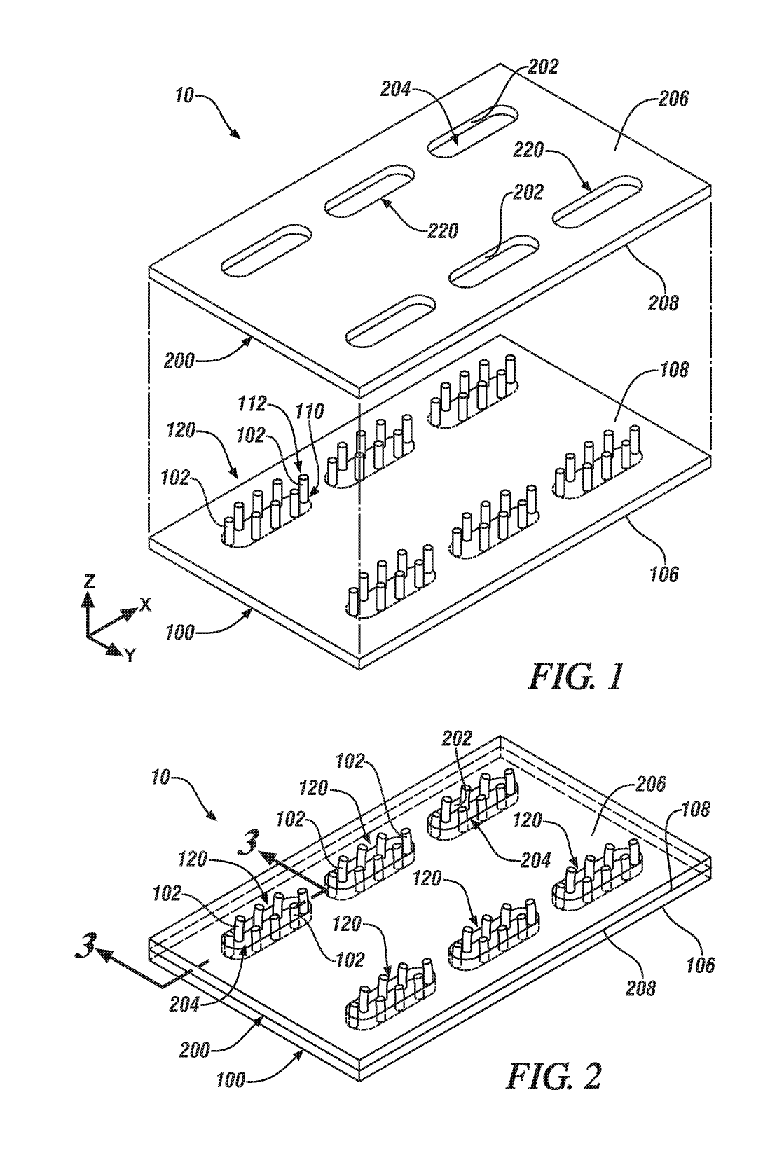

First component 100 may include various formations of alignment pins 102 thereon. For example, as shown in FIGS. 1 and 2, alignment pins 120 are arranged in a circular pattern generally corresponding to the shape of alignment aperture 204. In other embodiments, alignment pins 120 may be arranged along only a portion of the corresponding alignment aperture shape. For example, as shown in FIG. 4, alignment pins 120 are arranged only along one edge or side 220 of inner wall 202. In the illustrated embodiment, opposed pin groups 120 and 122 are required to align and couple first component 100 and second component 200. However, alignment pins 120 may be arranged in any pattern that enables system 10 to function as described herein.

In view of the foregoing, and with reference now to FIG. 6, it will be appreciated that an embodiment of the invention also includes a vehicle 40 having a body 42 with an elastically averaging alignment system 10 as herein disclosed integrally arranged with the body 42. In the embodiment of FIG. 7, the elastically averaging alignment system 10 is depicted forming at least a portion of a grill of the vehicle 40. However, it is contemplated that an elastically averaging alignment system 10 as herein disclosed may be utilized with other structural features of the vehicle 40, such as interior trim exterior side body moldings, door handle inserts, front and rear fascia trim, and other visible components.

An exemplary method of fabricating elastically averaged alignment system 10 includes forming first component 100 with at least one group 120 of alignment pins 102, and forming second component 200 with at least one inner wall 202 defining alignment aperture 204. At least one of the group of alignment pins 102 and the alignment aperture 204 is formed to be elastically deformable such that when alignment pins 102 are inserted into alignment aperture 204, at least one of alignment pins 102 and inner wall 202 elastically deform to an elastically averaged final configuration to facilitate aligning first component 100 and second component 200 in a desired orientation.

Described herein are elastically averaged alignment systems and methods that include a plurality of elastically deformable pins that are elastically averaged within a corresponding alignment aperture. A plurality of corresponding pins and apertures are further elastically averaged to align two or more components in a desired orientation. By using an abundance of small pins, elastic averaging can be achieved without drawing a large amount of material into one feature, which may cause sink marks or depressions. The small pins bend due to an interference condition with the edge of the associated aperture. Each pin will bend to a different degree based on the part variation causing the two mated features to average to a more precise position. The small pins reduce overall gaps and create a consistent gap between the two mated components.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising a plurality of alignment pins forming a first group of alignment pins; and
a second component comprising an inner wall defining an alignment aperture, the alignment aperture configured to receive the first group of alignment pins to couple the first component and the second component,
wherein the alignment pins comprise an elastically deformable material such that when the first group of alignment pins is inserted into the alignment aperture, at least a portion of the alignment pins of the plurality of alignment pins elastically deform to an elastically averaged final configuration to facilitate coupling and aligning the first component and the second component in a desired orientation.

2. The alignment system of claim 1, wherein at least one alignment pin of the plurality of alignment pins includes a ledge configured to support the second component in spaced relation to the first component.

3. The alignment system of claim 1, wherein the first group of alignment pins are arranged in a shape generally corresponding to a shape of the alignment aperture.

4. The alignment system of claim 1, wherein the first group of alignment pins are arranged along only a portion of a shape generally corresponding to a shape of the alignment aperture.

5. The alignment system of claim 1, wherein the alignment aperture is an elongated slot.

6. The alignment system of claim 1, wherein the first component further comprises a second plurality of alignment pins forming a second group of alignment pins; and
the second component further comprises a second inner wall defining a second alignment aperture, the second alignment aperture configured to receive the second group of alignment pins to further couple the first component and the second component,
wherein the second group of alignment pins comprise an elastically deformable material such that when the second group of alignment pins is inserted into the second alignment aperture, at least a portion of the alignment pins of the second plurality of alignment pins elastically deform to an elastically averaged final configuration to facilitate further coupling and aligning the first component and the second component in a desired orientation.

7. The alignment system of claim 1, the first component comprising more than one group of the elastically deformable alignment pins, and the second component comprising more than one of the alignment apertures, the more than one group of the elastically deformable alignment pins being geometrically distributed with respect to respective ones of the more than one alignment apertures, such that portions of the group of elastically deformable alignment pins of respective ones of the more than one group of elastically deformable alignment pins, when engaged with respective ones of the more than one alignment apertures, elastically deform to an elastically averaged final configuration that further aligns the first component and the second component in at least two or four planar orthogonal directions.

8. A vehicle comprising:
a body; and
an elastically averaged alignment system integrally arranged within the body, the elastically averaged alignment system comprising:
a first component comprising a plurality of alignment pins forming a first group of alignment pins; and
a second component comprising an inner wall defining an alignment aperture, the alignment aperture configured to receive the first group of alignment pins to couple the first component and the second component,
wherein the alignment pins comprise an elastically deformable material such that when the first group of alignment pins is inserted into the alignment aperture, at least a portion of the alignment pins of the plurality of alignment pins elastically deform to an elastically averaged final configuration to facilitate coupling and aligning the first component and the second component in a desired orientation.

9. The vehicle of claim 8, wherein at least one alignment pin of the plurality of alignment pins includes a ledge configured to support the second component in spaced relation to the first component.

10. The vehicle of claim 8, wherein the first group of alignment pins are arranged in a shape generally corresponding to a shape of the alignment aperture.

11. The vehicle of claim 8, wherein the first group of alignment pins are arranged along only a portion of a shape generally corresponding to a shape of the alignment aperture.

12. The vehicle of claim 8, wherein the alignment aperture is an elongated slot.

13. The vehicle of claim 8, wherein the first component further comprises a second plurality of alignment pins forming a second group of alignment pins; and
the second component further comprises a second inner wall defining a second alignment aperture, the second alignment aperture configured to receive the second group of alignment pins to further couple the first component and the second component,
wherein the second group of alignment pins comprise an elastically deformable material such that when the second group of alignment pins is inserted into the second alignment aperture, at least a portion of the alignment pins of the second plurality of alignment pins elastically deform to an elastically averaged final configuration to facilitate further coupling and aligning the first component and the second component in a desired orientation.

14. The vehicle of claim 8, the first component comprising more than one group of the elastically deformable alignment pins, and the second component comprising more than one of the alignment apertures, the more than one group of the elastically deformable alignment pins being geometrically distributed with respect to respective ones of the more than one alignment apertures, such that portions of the group of elastically deformable alignment pins of respective ones of the more than one group of elastically deformable alignment pins, when engaged with respective ones of the more than one alignment apertures, elastically deform to an elastically averaged final configuration that further aligns the first component and the second component in at least two or four planar orthogonal directions.

15. A method of manufacturing an elastically averaged alignment system, the method comprising:
forming a first component comprising a plurality of alignment pins that form a first group of alignment pins; and
forming a second component comprising an inner wall defining an alignment aperture, the alignment aperture configured to receive the first group of alignment pins to couple the first component and the second component,
wherein the alignment pins comprise an elastically deformable material such that when the first group of alignment pins is inserted into the alignment aperture, at least a portion of the alignment pins of the plurality of alignment pins elastically deform to an elastically averaged final configuration to facilitate coupling and aligning the first component and the second component in a desired orientation.

16. The method of claim 15, further comprising forming at least one alignment pin of the plurality of alignment pins with a ledge configured to support the second component.

17. The method of claim 15, further comprising arranging the first group of alignment pins in a shape generally corresponding to a shape of the alignment aperture.

18. The method of claim 15, further comprising arranging the first group of alignment pins along only a portion of a shape generally corresponding to a shape of the alignment aperture.

19. The method of claim 15, further comprising forming the alignment aperture as an elongated slot.

20. The method of claim 15, further comprising:
forming a second plurality of alignment pins on the first component that form a second group of alignment pins; and
forming a second inner wall on the second component that defines a second alignment aperture,
wherein the second group of alignment pins comprise an elastically deformable material such that when the second group of alignment pins is inserted into the second alignment aperture, at least a portion of the alignment pins of the second plurality of alignment pins elastically deform to an elastically averaged final configuration to facilitate further coupling and aligning the first component and the second component in a desired orientation.
